(19) United States
(12) Patent Application Publication
(10) Pub. No.: US 2008/0120675 A1
(43) Pub. Date: May 22, 2008

(54) Home gateway for multiple units

(75) Inventors: Amir Morad, Tel-Aviv (IL); Leonid Yavits, Herzlia (IL); Gedalia Oxman, Tel-Aviv (IL); Michael Khrapkovsky, Herzlia (IL); Ofer Austerlitz, Tel-Mond (IL)

Correspondence Address: Martin D. Moynihan;PRTSI, Inc., P.O. Box 16446, Arlington, VA, 22215, US

(73) Assignee: Horizon Semiconductors Ltd., Herzlia (IL)

(21) Appl. No.: 11/603,200

(22) Filed: Nov. 22, 2006

(51) Int. Cl. H04N 7/173

(52) U.S. Cl. 725/120

(57) ABSTRACT

A home gateway for a home media network. The home gateway comprises a number of input interfaces each configured for receiving encrypted & unencrypted data from a content source, a layout generation unit adapted to generate substantially simultaneously a number of different composite layout streams. Each one of the different composite layout streams is generated according to one or more of the number of input interfaces. The home gateway further comprises a number of output interfaces for providing a number of client stations with the ability to access one or more of the number of different composite layout streams in encrypted & unencrypted manner.

### FIELD AND BACKGROUND OF THE INVENTION

The present invention relates to communication systems and in particular to home gateways for receiving and transmitting video streams and displaying processed video layout streams on display units.

Digital set top boxes (STBs) are used to receive combined television streams including multiple compressed video channels through cable or satellite links and provide an output for display as television content on a home television set. The set-top box demodulates, decrypts and decodes the received video signals, and can also composite several channels into a composite screen, say a screen showing all the news channels together. Compositing may be combined with internally generated graphics to provide a display showing the various channels as small screens with the graphics filling the spaces in between, or the small screens may be combined with information, such as Electronic Program Guide (EPG) etc. The set top box provides the composite screen as a single video channel to the television set for display.

Usually, the incoming video signals are encrypted, in order to prevent viewing without payment, and one of the more significant tasks of the set top box is to decrypt the encrypted signals.

Some digital television sets themselves include some of the electronics of the set top box and thus are themselves able to perform the tasks of a simple set-top box, such as deciphering and decoding of a single or dual channel of a multiplexed compressed stream. Such digital television sets may have two input interfaces, The first is a compressed data interface which receives video data encoded in accordance with a certain standard, for example, MPEG-2 or MPEG-4-AVC standards and which would receive data from a satellite or data link and carry out the deciphering and decoding processing. The second is a raw data interface through which already uncompressed data is received from a set top box.

Some STBs provide additional services, which further improve the range of features available for the viewer. For example, some set top boxes are designed to allow the arranging of data which originates from a number of content sources for display on a television set. The content sources of course include a television channel stream, but may additionally incorporate e-mail, graphics, gaming, EPG, Internet information, etc. The STB generally separately receives data from each content source and arranges the received data into a single uncompressed blended output stream for display on the television set.

Some set top boxes include a large memory unit, normally a hard disk, which can be used for storing the data received from the different content sources. Such ability enables users to time their access to stored data, such as recorded content of the video channel. The memory unit further allows the users to view the stored data in trick-play modes, such as fast forward, fast backward, and slow motion. In addition, the users may access data from one channel while storing content from another source for future use. Some set top boxes include additional functionality and/or embedded consumer electronic (CE) appliances such as a DVD recorder, gaming etc.

Many households have a number of television sets which are used simultaneously, allowing a number of viewers to view the same or different television channels. Normally, each television requires a separate set top box but this is expensive to the provider companies who usually have to provide set top boxes for free or at a discount to their customers.

In order to reduce costs, it has been suggested to divide the set top box into two separate units. Each television is provided with a simplified set top box, which may be referred hereinafter as a thin client, to provide the basic functionality of a set top box such as deciphering, decoding and playback of video. Each of the thin clients receives the base video streams which are required for arranging its output stream from a central gateway set-top box which is a heavier, more expensive appliance and of which only one is required per household. The central gateway set-top box includes a large hard disk, embedded CE appliances, and additional modules which are designed to interface with cable or satellite links. The central gateway set-top box enables all the connected thin clients to operate the central gateway set-top box functionalities. For example, users may watch a DVD, play a game, store a base video channel or access it from any thin client which is connected to the central gateway set-top box. For example, if the user wants to view a display of a certain dual channel video streams and a display of an internet browser at the same time, the central gateway is designed to send the encrypted streams and the relevant HTML based data to the thin client. Viewing two channels at the same time may be carried out in a mode known as PiP (picture in picture) mode. The thin client is responsible for providing the PiP display to the television set by decrypting, decoding, and compositing the sources. The home gateway communicates with the thin client via network cable, or via same RF infrastructure used in regular STBs. In that regards, the thin clients also demodulates the incoming signal from the home-gateway. Such architecture reduces the cost to the provider of supporting multiple televisions per household but has, inter alia, two particular disadvantages. First, in order to allow the thin client to decrypt, decode, and composite streams, the thin client has to comprise almost all the components of a conventional STB and most of the processing power, as the features that need to be repeated are precisely those that require heavy processing does, just without the operating of the hard-disk, which is taken care of in the home-gateway. Therefore, the cost of a single thin client is relatively high. Second, as all the streams, which are needed for creating a composite display, such as a PiP, have to be transmitted at the same time to the thin clients, a relatively large transmission bandwidth is needed.

As the large hard disk, the embedded CE appliances, and the additional modules are commonly available to the thin clients, there is no need to use a different set top box for every user station (TV set). Using such a centralized arrangement reduces the costs relative to connecting a separate set top box to each user station. In addition, it allows users to share video content, gaming and other services. However, the costs of manufacturing, maintaining and repairing a large number of thin clients is still relatively high.

In an alternative solution, a central set top box only is supplied. An example for such a multi-display supporting set-top box is disclosed in U.S. Patent Application publication no. 2005/0076373, filed on Sep. 16, 2004, in which a multi-display set top box provides single channel video signals for display to a number of televisions. The central set-top box described cannot generate output streams that comprise more than one input video stream. In addition, so that the outlying televisions do not require their own thin clients, the output streams provided by the central set top box to each of the televisions comprise uncompressed data in a raw video format which can be used directly. The raw signal has to be transmitted over separate dedicated cables due to the high bandwidth. Another disadvantage of this example is that if the transmission is performed in the analog domain, as usually happens, the distance between the STBs and the televisions to which it is in connected is limited, or the connection is particularly susceptible to noise.

A more complex central set top box is disclosed in U.S. Patent Application Publication No. 2005/0034166, filed on Jul. 28, 2004, in which a home media gateway is used for handling multimedia data and for sending Internet data to thin clients.

PCT Patent Application Publication WO2004/062182, filed on Dec. 19, 2003 describes a gateway of an in-home audiovisual distribution system, in which a signal stream is transmitted wirelessly to a number of televisions using encoders. The encoders adjust the bandwidth they assign to each signal stream, according to a current backlog of packets of the particular stream, which are waiting for transmission.

There is thus a widely recognized need for, and it would be highly advantageous to have, a home gateway for allowing a plurality of devices to receive data streams devoid of the above limitations.

### SUMMARY OF THE INVENTION

According to one aspect of the present invention there is provided a home gateway for a home media network the home media network comprising content source inputs from any one of cable, satellite and digital broadcasting streams, digital data inputs including the Internet, and domestic content sources, and a plurality of terminal devices, each terminal device having a thin client, the home gateway comprising:

a plurality of input interfaces each configured for receiving data from a respective content source;

a multi-standard decoder unit capable of processing streams from the respective content sources, said processing being per stream according to a required one of a plurality of supported compression and encryption standards;

an internal stream generation unit able to create internally generated streams;

a layout generation unit adapted to generate substantially simultaneously a plurality of different composite layout streams, each one of said different composite layout streams being generated according to at least one of said plurality of input streams;

a multi-standard encoder unit capable of processing said composite layout streams, according to a variety of compression and encryption standards to produce reduced bandwidth output in a manner suitable for successful utilization by a thin client; and

a plurality of output interfaces for providing said composite layout streams to respective terminals.

According to a second aspect of the present invention there is provided a method of gatewaying streaming data for distribution to a plurality of terminal units, the method comprising:

a) receiving a plurality of incoming data streams in transmission formats,

b) receiving an internally generated stream,

c) processing said incoming data streams in transmission formats to manipulable formats,

d) performing manipulations on said manipulable formats to form new data streams for distribution to respective terminal units, said manipulations including at least one of the group comprising compositing and blending with said internally generated stream,

e) processing said new data streams to form outgoing data streams in transmission formats and

f) outputting said outgoing data streams to said terminal units.

According to a third aspect of the present invention there is provided a device for allowing the generation of a display according to a composite layout stream, comprising:

an input interface configured for receiving said compressed composite layout stream from a central home gateway via a local network;

a modulation unit, associated with said input interface, configured for modulating said compressed composite layout stream; and

an output interface unit for transmitting said modulated composite layout stream to at least one associated client station.

A method of configuring a home gateway for users connected via client stations, the method comprising:

gathering statistical information regarding the usage of said users;

using said statistical information for estimating usage patterns for said respective users; and

configuring said home gateway to allocate resources to respective client stations in accordance with said estimating.

According to a fourth aspect of the present invention there is provided a method for transmitting streaming media to an external client using minimal bandwidth, the method comprising:

a) receiving a plurality of incoming media streams in a transmission format;

b) obtaining an internally produced media stream in a manipulable format;

c) processing said incoming media streams from said transmission format into a manipulable format;

d) from at least two of said plurality of incoming media streams and said internal media stream performing manipulations to generate at least one composite layout stream in said manipulable format;

c) processing said at least one composite layout stream from said manipulable format into a transmission format; and

d) transmitting said at least one composite layout stream to said least one remote client station for processing into a playable format.

An electric circuit for allowing at least one remote client station to display a composite display, said electric circuit comprising:

an input interface configured for receiving at least one video stream and at least one stream of IP based content;

a layout generation unit adapted to generate substantially simultaneously a plurality of different composite layout streams, each one of said different composite layout streams being generated according to said at least one video stream and said at least one stream of IP based content; and

a plurality of output interfaces for providing a plurality of client stations with the ability to access at least one of said plurality of different composite layout streams.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of a home gateway, in accordance with one embodiment of the invention;

FIG. 2 is a block diagram that depicts the relationship among electronic components of a home media network, in accordance with one embodiment of the invention;

FIG. 3 is a block diagram that depicts the relationship among electronic components of a home gateway, in accordance with one embodiment of the invention;

FIG. 4 is a graphical representation if a screen display of one of the client station, in accordance with one embodiment of the invention;

FIG. 5 is a block diagram that depicts the relationship among electronic components of a thin client, in accordance with one embodiment of the invention;

FIG. 6 is a block diagram that depicts the Media CODEC device, in accordance with one embodiment of the invention;

FIG. 7 is a block diagram that depicts the implementation of a blade board using a Media CODEC device, in accordance with one embodiment of the invention;

FIG. 8 is a block diagram that depicts the implementation of home gateway using a Media CODEC device, in accordance with one embodiment of the invention; and

FIG. 9 is a simplified flowchart of an exemplary method for providing composite layout streams to a number of client stations, according to a preferred embodiment of the present invention.

### DESCRIPTION OF THE PREFERRED EMBODIMENTS

The present embodiments comprise an apparatus and a method for a home gateway allowing a number of client stations to receive different video streams substantially simultaneously, the individual streams including composite screens, graphics, web pages etc. The home gateway comprises one or more blenders that allow the home gateway to simultaneously transmit one or more different composite layout streams.

It should be noted that a video stream may be understood as a video channel, a program channel, a composite of several video streams, a composite of several video and audio streams, a composite of several video streams depicting a common object from different angles, a video stream associated with one or more audio streams, such a video stream which is associated with number of dubbing streams in a number of different languages, a subtitle stream, an analog video stream, a digital video stream, and an electronic program guide (EPG) stream.

The composite layout streams are constructed to be received by a number of client stations and to be displayed without substantial processing at the stations. The home gateway receives data from one or more different sources and generates data streams which are arranged for a display. The home gateway encodes the composite layout streams and modulates it before transmitting it to different client stations. As different client station may be used, the composite streams may be adapted for different kinds of client station. Using such a home gateway allows for a reduction in the necessary bandwidth for communicating with thin clients.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The present invention is directed towards a single home gateway which generates a number of different output display streams for direct use by a number of client display units. The home gateway is preferably included in a single housing which can be positioned at a distance from the display units. The different output display streams may be transmitted either directly to the display units or via a simplified thin client that preferably merely decodes the received output display stream without rearranging the layout thereof. In one embodiment of the present invention, the home gateway is configured for transmitting the composite steams to a remote location, say via the Internet or any other computer network.

Preferably, the home gateway comprises a number of layout arrangement units, or blenders, which are used to blend a number of video streams into a composite output stream which is encoded for display. The layout arrangement units may be designed to blend one or more video streams with graphics, EPG, e-mail, Internet data or other data.

In one embodiment of the invention, the layout arrangement units are designed to encode, encrypt, or convert data received from a number of different content sources into a one or more resultant blended output streams, each blended to serve one or several a separate clients. The resultant blended output streams are suitable for transmission via home networks. The home networks may be based on wired communication lines such as coax lines, power lines, telephone lines, etc. or on wireless communication infrastructure. As the layout arrangement units may be included in a single housing, their maintenance is simpler. Moreover, transmitting resultant blended output streams, which are already arranged for a display, reduces the bandwidth required for transmission, as only a single stream is delivered per client. This reduction is possible as there is no need to transmit multiple base video streams and other data generally used for generating output streams. As described above, data originating from the different content sources can be blended into a single video stream that may be encoded, indexed and encrypted in the home gateway. The home gateway outputs composite video streams which can be decrypted, decoded and displayed by the client display units without further processing.

As only simple processing is needed at the client display units for displaying the composite video streams, the client display units which are located at a distance from the home gateway, can be thin clients that comprise only minimal hardware and software settings, or totally software base, as described below.

In one embodiment of the present invention, each one of the client display units is connected to a blade board. The home gateway comprises a controller that dynamically assigns one or more blade boards serving different client display units. As different blade boards are assigned to different client stations (or to a different user), the user may configure the blade board according to a preferred configuration. In such a preferred configuration the user may configured a certain blade board to display the user's favorite channels or to define a certain picture in picture (PiP) configuration. The user may also adjust the video enhancement, the graphics, and web-browsing according to his preferences.

One or more of the blade boards may be configured for blending the streams together and to encode and encrypt the blended stream before sending it via the Link/PHY of the home gateway to the display unit, as further described below. Preferably, the controller includes a sensor which automatically identifies when one of the connected blade boards is inactive or inoperative and automatically changes the assignment of the blade boards in view of the identification of the inoperative blade board. Preferably, a user may indicate to the home gateway that a client display unit is not provided with a proper output stream. Preferably, each one of the blade boards is assigned with a different priority. Such a priority assignment can be used for determining the distribution of resources of the home gateway such as computational and memory resources. Preferably, the composite video stream is encoded using an encoding method having a high compression ratio such as the MPEG2 encoding, advanced video coding (AVC), and MPEG4 encoding.

Another embodiment of the present invention relates to a home gateway that is designed for compressing composite video streams before transmitting them to remotely located thin-clients. The home gateway generates one or more composite output streams from data received from a number of different sources. Preferably, the composite video stream is encoded using an encoding method having a high compression ratio such as the MPEG2, advanced video coding (AVC), and MPEG4 Part 10.

Preferably, the home gateway compresses and encrypts the composite output streams. Then, the home gateway transmits, via a Link/PHY such as an Ethernet PHY, the output stream to one or more destination display units. The compression is done after blending a number of different sources.

The home gateway may generate composite output streams for allowing direct connection with display units where the display units have embedded deciphering and decompression capabilities. Such capabilities are nowadays available in a standard digital TV (DTV). As further described below, such a direct connection allows more flexibility in transmission of the output stream.

One embodiment of the present invention relates to a method allowing a DTV to use an embedded internal demodulator, a descrambler and a decoder for displaying video signals received from a home gateway. Such an embodiment allows the DTV to directly receive video streams from the home gateway, and no intermediate hardware, such as thin clients, is required. Moreover, the home gateway may enable users with a variety of services which are not provided by the DTV. For example, using the home gateway the DTV may be used for displaying advanced graphics, combination of video streams and graphics, user defined still images, layout arrangements, digital video recording and advanced video post-processing functionalities, such as complex de-interlacing, etc.

Another embodiment of the present invention relates to a home gateway which includes a local CE interface for interfacing with CE appliances, such as video cassette recorders (VCRs), DVD players and recorders, camcorders, High Definition DVD (HD-DVD) and Blu-ray Disc (BD) players and recorders, portable video and audio players and a hard disk or disk-on-key video memory. The local CE interface is optionally included in the home gateway along with an input interface from a remote source, such as a cable and satellite interfaces, for receiving compressed video streams from different service providers. For example, the high-definition HDMI output of an HD-DVD, is connected to the “blade-board”, which in turns, decrypts, decode, blends, encodes, indexes & ciphers the stream on its way to the one or more clients.

Connecting a CE appliance to a home gateway allows users to access and share the CE appliance's outputs using the same remote control they use for accessing the home gateway, for example by switching channels. Preferably, when the home gateway serves a number of display units, the specific CE appliance's outputs may be displayed on any of the display units following receipt of a simple control signal from the viewer. It should be noted that in such an embodiment the CE appliance may be positioned in a location remote from all the display units, and gives the appearance to the viewer of being remotely operated.

A video stream received from the CE appliance may optionally be used instead of generating one or more video streams by the home gateway, when desired by a user. Preferably, a video stream received from CE appliance interface is used in forming a blended video layout which is combined with one or more video streams received through the remote source interface.

In one embodiment of the invention, the local CE interface is adapted to receive a number of video streams. In some embodiments of the invention, the local input interface is adapted to receive at least one video stream for each TV set serviced by the home gateway.

The home gateway is preferably controlled from several remote locations. In such an embodiment, the home gateway and the connected CE appliances may be stored in the house basement or in another hidden location. Such an embodiment removes the need for “bulky”, warm & noisy boxes in living rooms and bedrooms and saves on redundant cables and appliances. etc. Sharing of CE devices allows multiple users to watch the same HD-DVD (for example), and reduces cost since the user does not require a separate HD-DVD player say for his living room, and each bedroom.

In another embodiment of the invention, the local CE interface comprises a digital input interface, such as a digital visual interface (DVI) and high-definition multimedia interface (HDMI). Preferably, the local CE interface comprises an analog input interface such as a Separate video (S-Video) input. The input interfaces are used for receiving uncompressed video streams. Preferably, the local CE interface receives compressed video streams. In such an embodiment the home gateway is adapted to decompress streams received through the local CE interface and to convert streams received through the CE interface from an analog format into a digital format.

The local CE appliance interface is preferably connected to an external CE appliance. Preferably, one or more CE appliances are included inside the housing of the home gateway. In another embodiment of the invention, the local CE interface is an input interface for reading video streams from the CE appliances. Such an interface allows storing streams generated by the home gateway on a CE appliance (for example portable devices) for displaying at a later time.

Another embodiment of the invention relates to a home gateway that automatically transmits a fault message to a service provider when a malfunction is detected in one of the blade boards. The message may be transmitted using any method known in the art, for example via a back channel optionally in an Internet format.

A client station may be understood as a digital television, a thin client, high definition (HD) television, a cable receiver, a satellite receiver, a personal computer, a portable player, a client, a work station and a thin client.

A thin client may be understood as a client that has little hardware and no hardware or installed software. The thin client has access to software that is managed and delivered by a central home gateway. A thin client is an alternative to a full-function client such as a workstation.

A home gateway may be understood as a central set top box or any other electronic device which is designed to produce output on a conventional television set and connected to one or more communications channels such as telephone, integrated services digital network (ISDN), optical fiber, wireless transmissions or cable.

A blade board may be understood as any system of electronic circuits which can be regarded as a separate unit.

A content source may be understood as a cable link, a satellite link, a digital versatile disc (DVD) player, a video digital recorder (VDR), a camcorder, an external consumer electronic video appliance, a portable memory device, the Internet, a local area network connection, and a Video Home System (VHS).

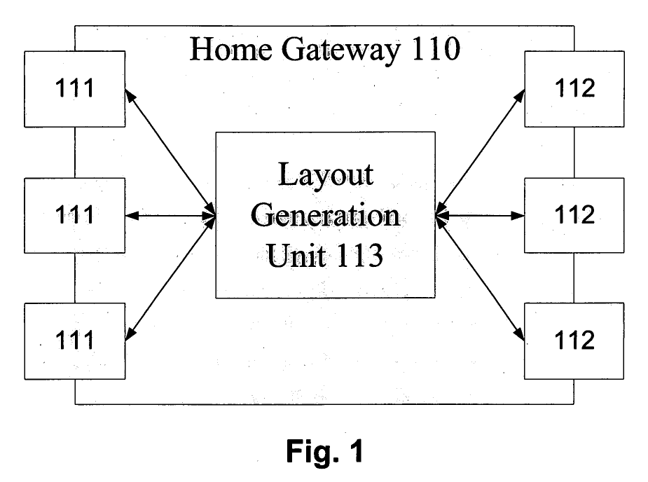

Reference is now made to FIG. 1, which is a schematic illustration of a home gateway 110, in accordance with one embodiment of the invention. The depicted home gateway 110 receives a number of data streams through designated input interfaces 111. The data streams are received from different content sources, as further described below. The data streams are routed to a layout generation unit 113. The layout generation unit 113 is configured to generate different video layout streams for display devices. As detailed below, each one of the different video layout streams is generated according to one or more data streams which are received from the designated input interfaces 111. Each video layout stream is arranged for a display by a remotely located client station. The video layout stream may be encoded or based upon more than one data streams. The different video layout streams are routed to communication interfaces 134, 112 which are connected to one or more communication links. The communication links allow simultaneous transmission of the video layout streams to a number of client stations. Such an embodiment allows a number of viewers to watch simultaneously different video layout streams, each comprised from one or more different data streams.

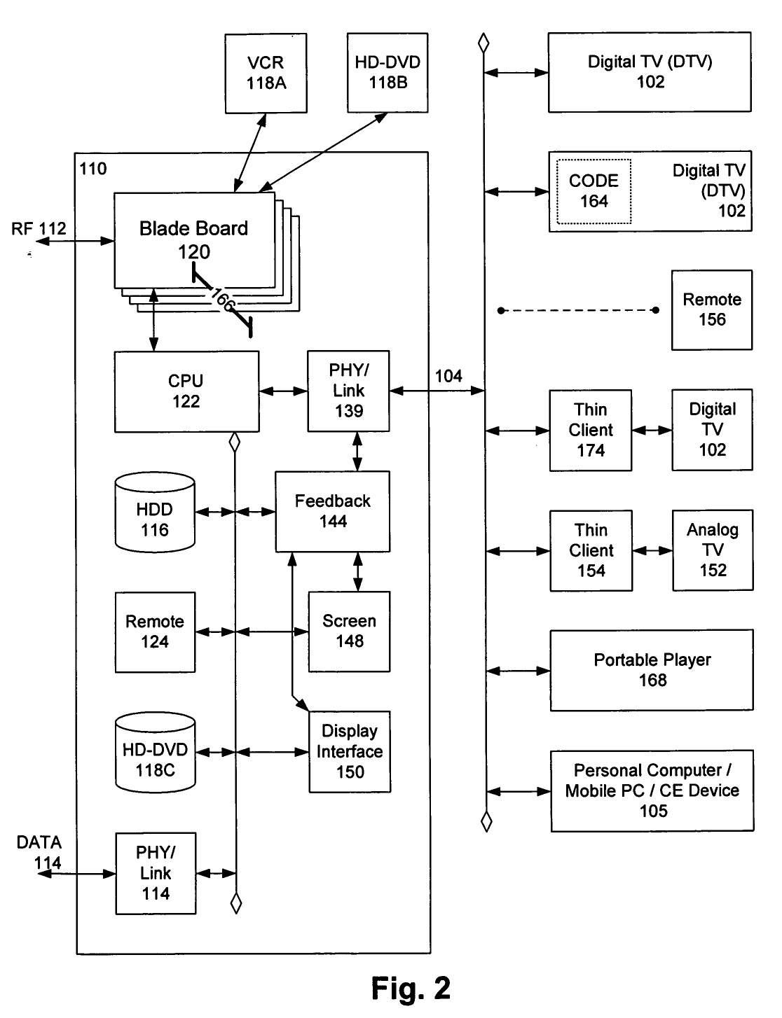

Reference is now made to FIG. 2, which is a schematic illustration of a home media network 100, in accordance with one embodiment of the invention. The depicted home media network 100 includes the home gateway 110 which is depicted in FIG. 1 and a number of display devices, such as DTVs 102, analog TVs 152, a personal computer 105, and portable players 168 which are connected thereto. The display devices 102, 152, 168 are connected to the home gateway 110 using a communication link 104. Preferably, the communication link 104 is an RF link.

The home gateway 110 optionally receives inputs from a number of content sources. The content may be one or more video streams, graphical objects, still images, text and other contents from one or more sources. The received inputs are used for generating video layout streams for the display devices. The video layout streams are generated according to instructions received from users of the display devices or from application software. The video streams are optionally received from an RF input link 112 or from a digital data link 114, 122. Preferably, video streams are received from one or more external video storage units, as shown at 118A, 118B and 118C. Other content such as graphics, still images, text, audio signals, web pages, interactive menus, electronic programming guides and interactive game information is optionally received through a data link 114, or through a communication interface 134, as described below. Preferably, the other content may be received from any other source or generated internally, possibly being received from RF input link 112 or through a data link 114 which is used for receiving video signals. Preferably, video streams are received via the communication interface 134 from a network connection using a modem such as V90 modem, cable modem, Asymmetric Digital Subscriber Line (ADSL) modem, Home network modem etc.).

When the video layout streams by home gateway 110 are transmitted to analog TVs, as shown at 152, the video layout streams pass through a thin client 154, which is used as an intermediate device, as further described below. However, when the video layout streams are transmitted directly to DTVs 102, they are preferably transmitted without passing through intermediate devices, such as thin clients or the like. As the video layout streams are directly transmitted to the DTVs 102, the video layout streams are in a format which can be handled by the internal decoder and the descrambler of the target DTVs 102. The thin clients 154 174, are designed to decode, decrypt or otherwise convert a provided stream which is originated from the home gateway 110 into a stream which is displayable by DTV 102 or analog TV 152. The thin client 154, 174 receives only a single stream, ready for a display, and does not perform layout arrangement tasks such as generating 2D and 3D graphics, decoding still images, blending of graphics, still images and video planes, etc.

### General Internal Structure of Home Gateway

As described above, the home gateway 110 includes a layout generation unit. The layout generation unit preferably includes a number of blade boards 120, each of which normally prepares the composited layout stream for a client station such as a DTV 102 or an analog TV 152, at any specific time. Organizing substantially all the hardware for each client station on a separate blade board 120 facilitates the maintenance of the home gateway 110. As each blade board 120 is a separate unit, malfunctioning blade boards 120 can simply be replaced with new blade boards without any further hardware or software adjustments. In addition, several redundant blade boards can be added to gateway 110, to allow what is known as “hot-swap” in case of detected failure. Hot swap comprises moving to a redundant blade board when an initial blade board fails. Such a hot-swap may be carried out automatically or by user command. The home gateway can be configured to launch a fault notice to the service provider.

The home gateway 110 preferably includes a central processing unit (CPU) 122 which is used for various calculations and controlling during the operation of the blade boards 120 and other elements of the home gateway 110, such as the hard disk drive (HDD) 116. The CPU 122 is connected to a remote control interface 124 which is designed for receiving control signals from client stations 102 152. It should be noted that the control signals may also be received via the communication interface 134, or via the digital data link 114. Preferably, the remote control interface 124 is configured to receive control signals directly from remote controls 156, each associated with a specific client station. Preferably, control signals are received from a central remote control (not shown) which is designed to control more than one client station 102 152. For example, control signals may be received from a parent remote control which is designed to control the content which is transmitted to all the client stations 102 152 in the home media network 100. It should be noted that remote units such as the remote unit 124, may be coupled and associated with one or more of the blade boards in a manner that allows it to control the associated blade board.

In one embodiment of the present invention, blade boards 120 communicate with each other directly through a designated connection, such as a bus 166 or an Ethernet network. Preferably, the connection is used to provide a layout of one of the blade boards 120 as an input to another blade board 120. The blade boards 120 may communicate through a multiplexer (not shown), the CPU 122 or both.

Each one of the blade boards 120 preferably generates a compressed, and preferably indexed & encrypted, video layout stream which is designed to be processed and displayed by an associated display device. One or more communication interfaces 134 transmit the compressed video streams to the client stations over one or more links 104. The communication interfaces 134 may be physical layer protocol (PHY) and link units which are used for unidirectional or bidirectional communication. When a communication link 104 is used for transmitting video streams to a number of client stations, each client station, such as the DTV 102, the personal computer 105, or the thin clients 154, 174 optionally receives signals transmitted on the communication link 104 and extracts therefrom the video layout stream which is directed to it. Preferably, the communication link 10 is a bidirectional communication channel which is used to transfer both compressed encrypted video streams and to enable command and data exchanges. Preferably the link is further designed for allowing DRM key exchanges etc.

Preferably, each DTV 102 or another client station includes a cryptographic code card, as shown at 164, or an embedded downloadable conditional access system (DCAS), which are used for decrypting signals received from an encryption unit (not shown) of the associated blade board. The code card 164 is preferably configured to identify video streams and signals transmitted on the communication link 104 which are to be captured and used by the related DTV 102. Other streams and signals are preferably disregarded or discarded upon reception. The code card 164 preferably comprises an OpenCable™ decrypting card, such as CableCard™, which is known in the art.

Preferably, the home gateway and the client stations which are connected to the communication link 104 are configured to decrypt identification codes and DRM keys.

Preferably, one or more of the client stations 102, 105, 154, and 174 receive encrypted video signals from associated blade boards 120, while other client stations receive non-encrypted signals. For example, if a code card 164 of one of the client stations 102, 105, 154, and 174 is damaged, or if the video-stream content has an appropriate security clearance, the related client station may receive unprotected signals from the HDD 116, until a replacement code card 164 is received. Preferably, the home gateway 110 is designed to allow the deactivation of encrypting transmitted layout video streams. Such ability may be used to manage the transmission of video channels that comprises copyrighted content. It should be noted that the video streams received from home gateway 110 may be demodulated, descrambled, decoded or otherwise processed by the client stations.

### Blade Board

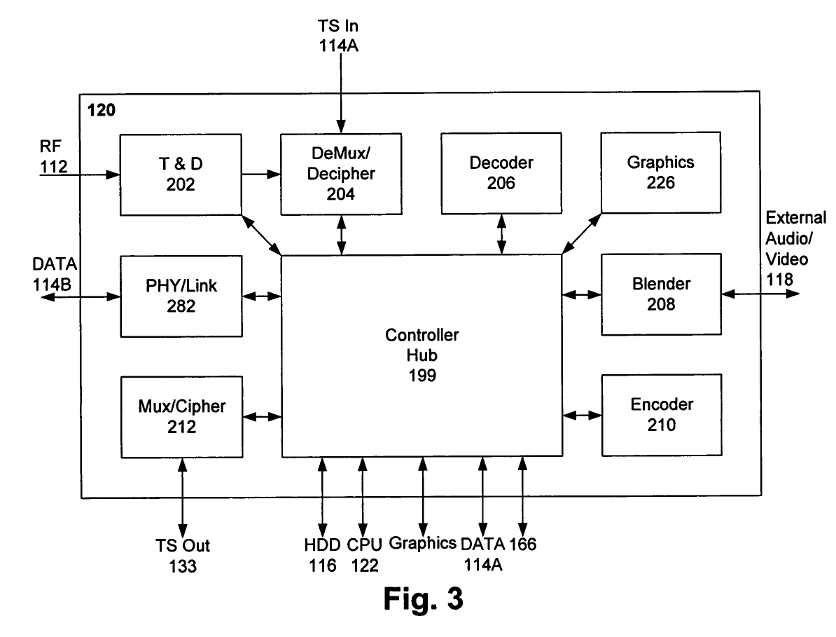

Reference is now made to FIG. 3, which is a schematic illustration of a blade board 120, in accordance with one embodiment of the invention. The depicted blade board 120 is connected to communication interfaces 134, the HDD 116, the designated connection 166, and the CPU 122 as depicted in FIG. 2. However FIG. 3 further depicts internal components of each one of the blade boards. As described above, each blade board is associated with a client station, such as DTV 102, analog TV 152, or a portable player 168 which is connected to a home gateway 110. The depicted blade board 120 preferably includes two units each comprising a tuner and a demodulator (TD) 202. Each TD unit is designed to be tuned on a certain video channel which is provided on an RF input link 112 and to transfer the received signals to a demultiplexing (demux)/decipher unit 204.

The blade board 120 may also receive a number of video channels from an Ethernet network, preferably via a data over cable systems interface specification (DOCSIS) Modem or an ADSL modem. As the received channels may still be encrypted, they are forwarded via the data connection 114B to the demux/decipher unit 204.

The demux/decipher unit 204 preferably de-multiplex the incoming transport/program stream, indexes it, and removes any encryption of the compressed video signals and transfer the signals to a decoder 206, which decodes the received compressed video signals into uncompressed raw video data. Preferably, the blade board 120 comprises a single PHY and a link interface 282 which is designed to receive signals from data interface 114A, such as video or other element data signals. The single PHY and a link interface 282 is preferably configured to transfer the signals either to the demux/decipher unit 204 or directly to a blender 208, depending on whether the received signals require decryption, decoding or both.

The raw video data is transferred to a blender 208, which is designed to generate a raw video representation of the combined stream and graphics layout that can be displayed on a client station which is currently associated with one of the blade boards 120. The raw composite video layout is provided to an encoder 210. The encoder is designed to compress the video layout into a compressed format, according to the associated client station. Clearly, different formats are used for different client stations. For example, the encoder is configured to generate signals in an MPEG-2 format, an AVC/H.264 format or a VC-1 format for DTVs 102 or for thin clients which are designed for DTVs 174. The compressed video layout stream is optionally transferred to a multiplexing (mux)/cipher unit 212, which multiplexes, indexes and ciphers the video layout to prevent unauthorized use thereof. The encryption is performed according to an encryption method negotiated by the central unit with the terminal units, and is of course supported by the supported by the terminal units, whether they be DTVs 102, DTVs with code cards 164, thin clients 154 for analog TVs or thin clients for DTVs 174.

### Inputs

As described above, in one embodiment of the present invention the blade board 120 is designed for receiving base video streams from a single RF input link 112, such as a cable link or a satellite link. Alternatively, the home gateway 110 may interface with a number of RF input links 112, for example of both cable and terrestrial or satellite and terrestrial networks. Each RF link 112 optionally carries a number of compressed video channels. Optionally, the video channels, which are received on RF input link 112, are encrypted. Base video streams and other information streams may also be received from the communication link 104.

It should be noted that two or more interfaces which are designated for allowing communication with an external device such as the HDD interface 116, the bus connection 166, the data connection 114A, the CPU interface 122 and even the PHY/Link connection may be grouped together and channeled via the controller/hub 199. Preferably, the controller/hub 199, may be coupled to one or more of the following interfaces: an industry standard architecture (ISA) interface, a peripheral component interconnect (PCI) interface, and a PCI-Express(PCIe) interface. In such an embodiment the CPU 122 may have a suitable interface as well, preferably to facilitate fast bidirectional communication. Preferably, PC architecture is used to connect the blade board 120 and the CPU 122. In such an embodiment the CPU interfaces are connected to multiple printed circuit board (PCB) boards via a PCIe interface.

Preferably, the controller/hub 199 may have an embedded CPU, to handle system level and other tasks. Preferably, the controller/hub 199 may function as n-to-n cross-switch, allowing bidirectional & parallel communication between all units which are connected to it.

Home gateway 110 may also receive video signals of more than one video channels through a data interface 114A. The data interface may comprise, for example, a packet based network interface, such as a USB interface, a MoCA interface, a HomePlugAV interface, an Ethernet interface, an HDMI/DVI interface, a UWB interface, a Wi-Fi interface or a Firewire IEEE1394 interface or any other digital interface known in the art. For example, the video channels may be received over the Internet or through one or more packet based networks, for example according to Internet compatible protocols such as TCP/IP, HTTP, ADSL, DOCSIS, and Ethernet. Preferably, the single PHY and a link interface 282 is adapted to receive signals in different interface formats of some or all of the above listed types of interfaces and formats.

Similarly to the data interface 114A which is used for receiving video and still images into the blender 208 via the controller/hub 199, another data interface 114B may be used to receive data via the PHY and the link interface 282. Preferably, a common data interface is used for receiving both video streams and other types of media. In some embodiments of the invention, data interface 114B comprises a bi-directional interface which allows transmission of data from home gateway 110 over the Internet, for example by allowing uploading movies which are stored in the HDD 116 via the Internet.

Preferably, the PHY/Link interface 282 is directly connected to the mux/cipher unit 212 and to the demux/decipher unit 204. In such an embodiment, the PHY/Link interface 282 allows users to receive services from the home gateway at the remote client station which is associated with the blade board. For example, in such an embodiment a user can receive a video stream from the HDD 116 via the data-port 114.

The home gateway 110 preferably receives video streams from one or more external video storage units, such as a VCR and a DVD or any other CE appliances. Although only one external DVD and one external VCR are shown, it may be possible to connect to a number of external storage units of the same type to the home gateway 110. One or more CE appliances may also be included within the housing of the home gateway 110. The home gateway 110 preferably includes an internal memory unit, such as an HDD 116, which stores video streams for playback or allowing the viewer to pause the display. Preferably, a direct connection (198) between the HDD 116 and an external port which leads to the external audio/video storage units 118 is provided. The direct connection allows the external storage units to copy content which is stored on the HDD 116 and to store it on a transportable media such as a CD or a DVD, in accordance with any applicable DRM scheme.

### Blender

A description is now provided of the blender 208. In one embodiment of the present invention, in addition to receiving video input streams from the decoder 206, the blender 208 receives one or more video streams from the external audio/video storage units 118, the data interface 114A, and the HDD 116.

The blender 208 optionally further receives data that does not represent video data. Such data may be audio, text, electronic program guide (EPG) data, still images, graphics, and other non-video data which is incorporated into the displayed output stream.

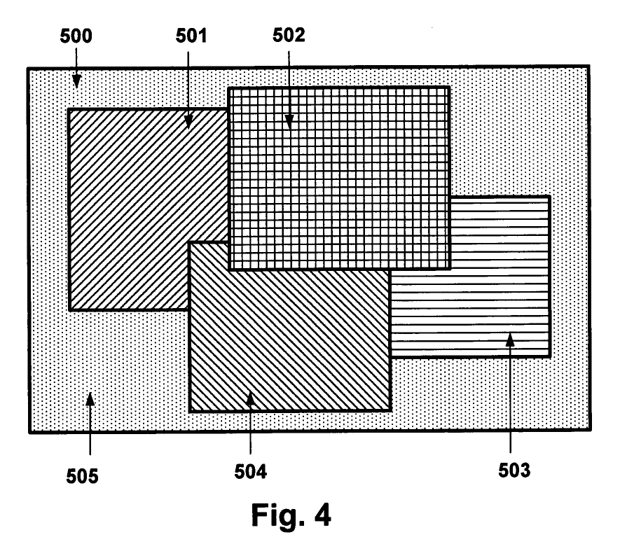

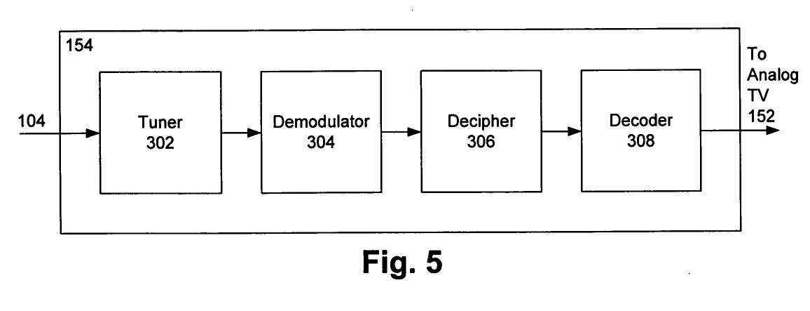

Reference is now made to FIG. 4, which is an exemplary graphical representation of a display device such as a DTV or an analog TV which is used to display the output video stream that has been generated using the blender of the blade board, according to one preferred embodiment of the present invention. As depicted in FIG. 4, the blended composite stream 500, which is displayed on the display device allows, for example, the display of a graphical view of the electronic program guide EPG 501, a still image 502, an internet browser 503, and video streams 504 and interactive background 505. All planes are blended together to form a composite screen 500.

Reference in now made, once again, to FIG. 3. The non-video data is optionally received externally, through the direct data interface 114A. The data interface is connected to the PHY 114B, or through the RF input 112. Preferably, the data is received from CPU 122 and from an internal memory of blender 208. In accordance with this alternative, the displayed data may include, for example, information on the status of home gateway 110 or on the operation status of home media network 100. Such an embodiment allows the home gateway 110 to generate display signals that represents volume settings and stream layout instructions.

In one embodiment of the present invention, the blender 208 is capable of decoding still images which are received in compressed form. Preferably, the blade board 120 includes a graphic engine 226, which prepares graphics to be included in output streams by blender 208. The graphic engine 226 receives graphic commands from other elements of the blade board 120 and returns two or three-dimensional graphic objects prepared based on the received commands. Preferably, graphic engine 226 generates a number of complete full-resolution planes of the graphics, to be combined with one or more video planes, still image planes, or the combination thereof by the blender 208. The blender has alpha-blending capabilities to allow blending to define transparency levels as known in the art. Preferably, the graphic engine generates portions of graphics which are arranged with each other and combined with video streams using the blender 208. Preferably, the home gateway 110 includes a central graphic engine that provides enhanced graphics to all the blade boards that require such services.

The blender 208 of one blade board 120 may receive the output of blenders of one or more other blade boards, via the controller/hub 199, preferably through the bus 166 or through an Ethernet network. Preferably, the CPU 122 assigns a number of blade boards 120 to a single client station. In such an embodiment, one blade board provides output streams to the other blade board instead of providing outputs to the associated client station. In such an embodiment, the user can simultaneously view four video streams on a client station. In another embodiment, the outputs of one blade board are provided, in parallel to the output of another blade board 120, to a common client station such as a DTV 102 or a thin client 154 174. For example, such a feature allows monitoring of one client station by another client station. Thus, parents can view on one client station, the content of the video streams viewed by their children on another client station. The output of each one of the blade boards 120 may be provided to an external audio/video storage unit 118, to the HDD 116, or to both simultaneously, according to the relevant DRM scheme. In one embodiment the output of one blade board is provided to another blade board. Thus, for example, a user can view three or more important video channels at the same time, while storing the same or other channels for a later point in time.

The blender 208 preferably receives layout instructions from CPU 122, preferably via the controller/hub 199. According to the layout instructions, the blender 208 generates a layout stream provided to the DTV 102 which is associated by the blender 208. The layout may be a simple layout that includes an unchanged single video channel which is received from the RF input link 112, the HDD 116, the direct data interface 114A, the data interface 114B, or the external audio/video storage unit 118. The layout may also be a composite layout that includes graphics, still images, text sections or a plurality of video streams. A composite layout stream may include, for example, a large display of a first channel and a small display of a second channel or two displayed channels having an equal size.

As described above, the blade board 120 comprises a number of input interfaces which are designed for receiving video and audio signals, such as the interface for receiving data signals from the external audio/video storage 118, the connection to the HDD 122, the PHY/Link 282, etc. It should be noted that the received data may be either digital or analog. The analog data signals, such as s-video signals and composite signals may be received via an Analog to Digital unit, which is used for digitizing the received signals before they are delivered to the blender 208. The received digital signals may either fed into the blender as raw data without any processing, for example when the received signals are in DVI format, or decrypted using the demux/decipher unit 204 before being fed into the blender, for example when the signals are in HDMI format. In one embodiment of the present invention the home gateway has a built-in CE appliance, such as a built-in DVD, built-in HD-DVD, or built-in BluRay drive. In such an embodiment the blade board reads the encrypted MPEG-2/MPEG-4 files from the DVD drive and transfer the signals to the demux/decipher unit 204 and then to the decoder 206 before it transfer the signals directly to the Blender.

As described above, blenders of different blade boards 120 preferably generate an output stream that represents different content. Therefore a number of blenders from different blade boards may require shared resources for one or more complex tasks, such as 3D graphics manipulation, substantially simultaneously.

Note that, the term “substantially simultaneously” is used in this description to denote the fact that a memory source such as a storage device or a computational source such as a CPU may be accessed or used at the same time to within the accuracy of a reasonable deviation, typically measured in clock cycles of the machine.

It will be appreciated that memory and access resources are limited and can be used substantially simultaneously only by a predetermined number of blenders.

Preferably, during the normal operation of the blade boards 120, one or more of the blenders 208 generates an output stream which composites a number of video streams. While all the blade boards 120 may have the same capabilities, in some embodiments of the present invention different blade boards have different capabilities.

In some embodiments of the invention, the blender 208 is used to generate a composite layout stream that includes a partial portion of a base video stream. For example, the partial portion comprises pixels from the central portion, the right half portion, or the left half portion of each image of the base video stream. In accordance with these embodiments, only a chosen portion of the video streams is displayed on a client station's display, while taking up a relatively small area of the display.

Preferably, resolution changes are performed by the blender 208. Preferably, in accordance with this alternative, the resolution of the output streams is resized according to the size of the display of the client station that receives the stream, the available bandwidth of the communication link, or in accordance with the user selection. Preferably, the blender 208 is designed to change the frame-rate and bit-rate of the received compressed streams in accordance with the available bandwidth or the user selection. Methods for performing such adjustments are well known and hence will not be described here.

For example, if a stream is provided to a portable player 168, the resolution of the output streams is resized according to the size of the display of the portable player. Such an embodiment can clearly reduce the storage and bandwidth which are required for transmitting the output streams. Preferably, the output streams are encoded by encoder 210 in a format different from the format according to which the received data streams were encoded. Thus, an overall transcoding can be performed between different standards, such as MPEG-4 part 10—MPEG-2 conversion, MPEG-2—MPEG-4 part 10 conversion, and MPEG-4 part 10—VC-1 conversion.

Preferably, the blender 208 comprises a scaling module which based upon user preference, is designed to support functions such as reconstruction of a video frame or image to have a larger number of scan lines or pixels (upconversion) and reconstruction of a video frame or image to have a smaller number of scan lines (downconversion) which are needed for example, in order to render an HDTV picture on a standard TV set, or downscale several video & graphics planes so all planes could be blended together in PiP fashion. Preferably, the blade board includes a bypass path (not shown) which leads the output of demux/decipher unit 204 to the input of mux/cipher unit 212 or leads the output of a TD 202 directly to the communication interfaces 134, or the data links 114A and 114B. The bypass path is optionally used when a simple display is requested, in order to avoid unnecessary use of computational resources.

It should be noted that two or more blade boards may cooperate in generating a common output stream. Such an embodiment can be utilized for generating a very high resolution picture, for example for a home cinema system. Preferably, each blade board prepares the layout stream for one sector, such as a half or a quarter of the display.

### Tuner, Receiver, and Decryption

FIG. 3 depicts a blade board 120 that comprises several TD units 202 which allow to generation of a composite output layout stream that includes two different video channels from a common RF input link 112. However, the blade board 120 may include only one TD unit 202 or more than two TD units 202. The demux/decipher unit 204, the decoder 206 and the blender 208 are optionally implemented using any method used which has been used for constructing set-top boxes and home media gateways, that control the layout of a single client device. Such methods are generally well known and therefore are not described here in greater detail.

It should be noted that if encryption or decryption are not required, the blade board 120 may be constructed without mux/cipher unit 212 or demux/decipher unit 204 respectively. In some embodiments of the invention, demux/decipher unit 204 is included in blade board 120 and when decryption is not required, demux/decipher unit 204 is bypassed.

### Encoder

In some embodiments of the invention, the encoding is performed according to a compression method such as MPEG-4 part 10, AVC, VC-1, MPEG-2 and any other method which achieves compression in a suitable ratio.

Preferably, the encoder 210 is configured to operate according to several different coding standards, including MPEG-2, AVC, MPEG 4 part 10 and VC1. The decoder which is positioned in the thin client or the DTV is respectively adjusted to handle such formats.

The encoding of the generated layout stream allows transmission of the generated composite output stream to a remote display unit, without distance or noise limitations which generally affect transmitted uncompressed streams, say in HDMI or DVI formats. In an exemplary embodiment of the invention, the generated layout is transmitted to client stations which are located in different places in the user's home.

Prior to the actual encoding process, the input video can be scaled using the aforementioned scaling module, which is able to perform both up-conversion and down conversion. In addition, the input video stream can be pre-processed according to a number of applications such as noise filtering, and estimating picture complexity measurements, which may be used later in the encoding process for improving the encoding rate.

Encoding the output stream which is transmitted from the home gateway to the client stations allows transmission on links with limited bandwidth and/or transmission of a large number of output streams on a single link, for example using advanced television systems committee (ATSC) modulation or multiple networking such as home programmable network access (HomePNA), Home PlugAV, multimedia over coax alliance (MoCA®), Wireless networks, etc. Preferably, the encoded composite output streams are transmitted over an RF link using an existing home infrastructure (coaxial cable), to the display units, thus not requiring any special cabling for transmission of the screen layout video streams, or through the Ethernet connection via a cable or an ADSL modem to a remote client location.

Preferably, the encoder employs a quality of service (QoS) scheme which measures the available bandwidth of the data links 114A, 114B and the communication link (shown at 104 of FIG. 2), and then, based thereupon, the encoder assigns each client station with a suitable Bitrate, Framerate, resolution and encoding algorithm scheme, so as to provide the best service for the resources available.

### Encryption

Reference is now also made, once again, to FIG. 2. Preferably, the same encryption method which is used for transmitting over RF input link 112 to demux/decipher unit 204 is used by mux/cipher unit 212 for transmitting to DTVs 102 152. In another embodiment, different encryption methods or different encryption keys are used by mux/cipher unit 212 and by the demux/decipher unit 204. Preferably, for the sake of the simplicity of the production and configuration of the blade boards, the same encryption method is used by all the blade boards of a certain home gateway. Alternatively, different blade boards 120 use different encryption methods. For example, when it is desired to prevent from one or more DTVs from viewing information directed to other DTVs 102. Preferably, code cards 164 have different levels of decryption capabilities from a decryption hierarchy. High priority code cards 164 can decrypt all levels of encryption, while low level code cards 164 can only decrypt low levels of encryption. Preferably, the demux/decipher unit 204, the mux/cipher unit 212, and the code cards 164 may be designed to accept multiple encryption keys, and each blade board 120 will auto-negotiate with its client counterpart regarding an appropriate set of DRM keys that shall be used through a viewing session. Preferably, these keys can be exchanged through the viewing session, allowing extra content protection. Optionally, CPU 122 instructs mux/cipher units 212 on the encryption level they are to use according to a restriction level of the video channels they display.

In an exemplary embodiment of the invention, a DTV 102 in a children's room has a low level code card 164, while the parent's DTV has a high level code card 164. Each channel received on RF input link 112 is optionally accompanied by a restriction level rating which is used by CPU 122 in instructing mux/cipher units 212 on which encryption level to use. Preferably, the home gateway 110 applies image recognition or other suitable methods on the received video streams in order to determine which encryption level should be used. For example, video channels which are to be restricted may include an identification symbol on a corner of the display, which identifies the required encryption level. Preferably, scenes to be restricted are automatically identified by the home gateway 110 according to color and scene combinations. Methods for restricting scenes are generally well known and therefore are not described here in greater detail.

The mux/cipher unit 212 is preferably configured according to a specific encryption method. A replaceable hardware card, which can be electronically coupled with the home gateway 110, may be used to determine one or more encryption methods according to which the blade boards 120 of the home gateway may be operated. The specific encryption method is implemented by the mux/cipher units 212 using a software module, a hardware module, or the combination thereof. In some embodiments of the invention, when it is determined that a certain encryption unit has been hacked, the encryption method is immediately replaced, for example by transmitting an executable update patch to CPU 122, for example by email. The encryption method may be implemented in the client station 102, 154, 174 and in the home gateway 110 by the same entity, which can easily replace the hardware and the software used for implementing the encryption method.

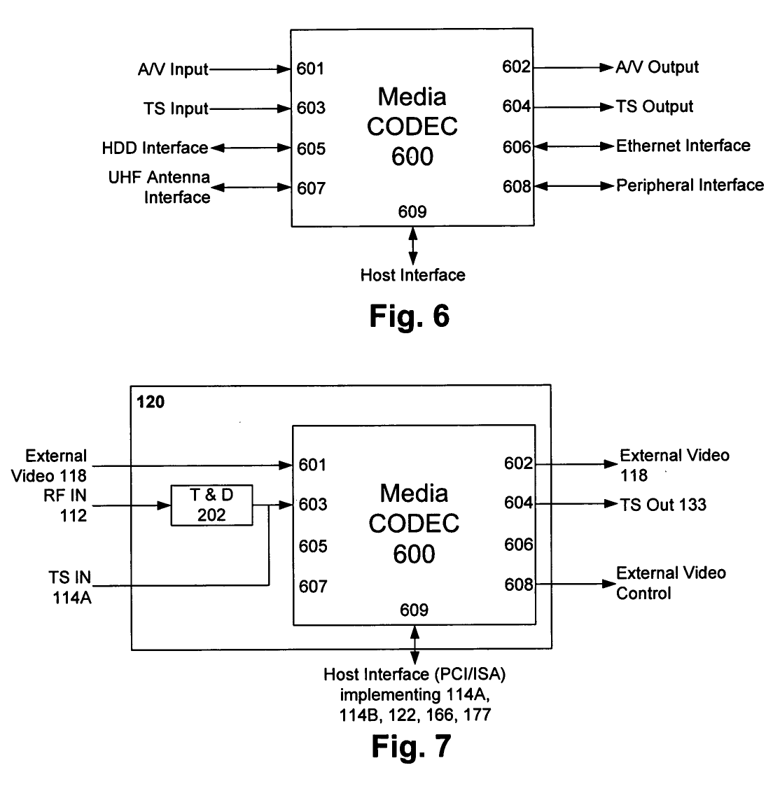

Reference is now made to FIG. 6, which is a graphical representation of a media codec 600, as described in a co-pending patent application, which has been filed concurrently with the present application and is herein incorporated in its entirety by reference into the specification. The media codec device 600 receives video, audio, and data streams and performs a sequence of actions according to one or more of the following sequences:

(a) De-multiplex, decrypt, and decode the received data streams in accordance with one or more algorithms and then to index, post-process, blend and playback the received data streams;

(b) Preprocess, encode in accordance to one or more compression algorithms, multiplex, index and encrypt a plurality of video/audio & data streams;

(c) Transcode in accordance with one or more compression algorithms, a plurality of video, audio & data streams into a plurality of video/audio & data streams;

(d) Perform a plurality of real-time operating system tasks, via embedded CPU;

(e) Any combination thereof.

The media codec device 600 comprises one or more of the following interfaces:

(a) An audio/video input port 601 that integrates analog & digital video & audio inputs. Preferably, the Input port 601 comprises a composite and s-video interfaces and analog audio interfaces such as a microphone port. Preferably, the Input port 601 comprises digital video interfaces such as CCIR656 (ITU-R BT.656), digital vision optics (DVO), LCD, DVI, and HDMI with HDCP. Preferably, the Input port 601 comprises digital audio interfaces such as integrated interchip sound (I²S) and Sony/Philips digital interface format (s/pdif) input, and the like.

(b) An audio/video output port 602 that integrates analog & digital video & audio outputs. Preferably, the Output port 602 comprises video interfaces such as a composite and s-video interface, and analog audio interfaces, such as a microphone port. Preferably, the Output port 602 comprises the digital video interfaces such as CCIR656, DVO, LCD, DVI, and HDMI with HDCP. Preferably, the Output port 602 comprises digital audio interfaces such as I²S, S/PDIF input, and the like.

(c) A transport stream (TS) input port 603, which may have a number of serial/parallel transport stream interfaces. Each interface supports multi-channel media content and the like.

(d) A TS output port 604, which may have a number of serial/parallel transport stream interfaces. Each interface supports multi-channel media content and the like.

(e) An HDD Interface 605, which may have a number of interfaces such as serial advanced technology attachment (SATA), advanced technology attachment (ATA), advanced technology attachment packet interface (ATAPI), and integrated drive electronics (IDE) interface etc.

(f) An Ethernet interface 606, which may have a number of 10/100/1G Ethernet ports, MII and GMII interfaces, and the like.

(g) A UHF Antenna Remote Interface 607, which may support a number of UHF and Infra-Red remote controls, and the like.

(h) A peripherals interface 608, which may, have a number of interfaces such as infrared data association (IrDA) interface, IR blaster interface, IR keyboard interface, USB interface, FireWire (IEEE1394) interface, standard product interface (SPI), Serial Signal Interface SSI, universal asynchronous receiver transmitter (UART) interface, general purpose input/output (GPIO), and the like.

(i) A host interface 609, which may take the form of PCIe, PCI, ISA and the like.

Reference is now made to FIG. 7 which is a graphical representation of a blade board 120 that integrates the media Codec 600 of FIG. 6, according to one preferred embodiment of the present invention. The TD unit, 202, the external video input 118, the RF input 112, the TS input 114A, and the TS output 133 are as in FIG. 3, however FIG. 7 depicts a blade board 120 that utilizes the media Codec 600 instead of a number of internal components. In such an embodiment, the blade board 120 receives audio, video, and data streams via the external audio/video interface 118 into and out of the media Codec 600. Such devices may be controlled using the External video control interface.

The blade board 120 receives RF inputs from an RF Interface 112 and forwards them into an internal TD unit 202 that feeds the demodulated stream to the TS input of the Media Codec 600. A multi-channel transport stream, which is generated by the main board CPU, is received via the transport stream input 114A. The multi-channel transport stream preferably includes streams from the main HDD 116 which have been accessed by a certain blade board 120. In such an embodiment, the TS output interface 133 is designed to transmit compressed, multiplexed, and encrypted outputs from the TS output 604 of the media codec 600. The outputs of this interface are routed back to the system CPU. The blade board 120 further comprises a host interface such as a PCI/ISA interface which is designed to access the Media codec 600, from a designated host interface 609, for example, taking the output of Media CODEC 600 and forward them to the host bus interface 166 which is shared by a number of blade boards 120 and the system CPU 122. The host bus interface 166 is used to exchange data, instructions and the like.

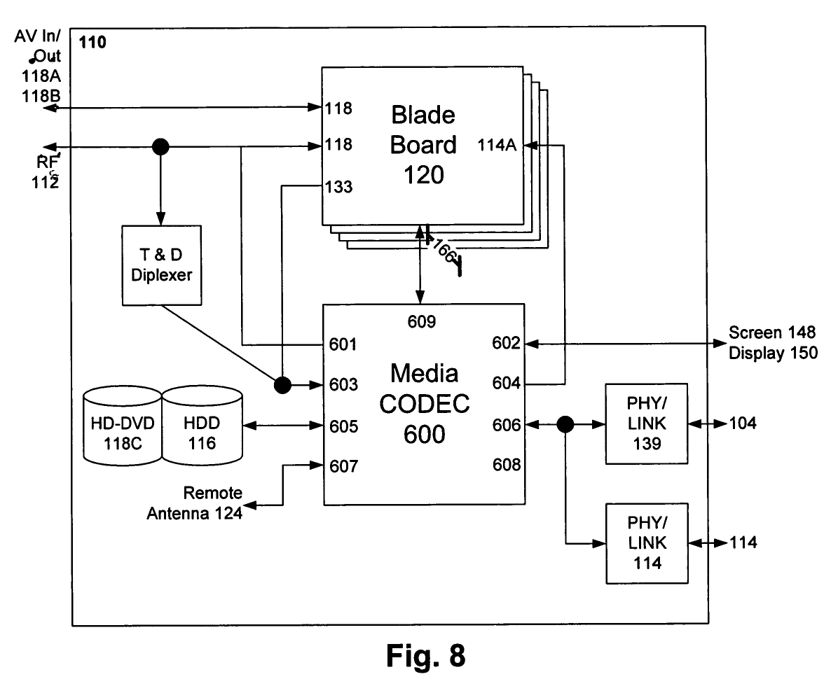

Reference is now made to FIG. 8, which is a graphical representation of a home gateway 110, according to one preferred embodiment of the present invention. The interfaces 112 18A 18B 104 114, 148, 150 the HDD 116, the set of blade boards 120 and the PHY/LINK 139 114 are as depicted in FIG. 2, however a central media codec 600 is used to serve the set of blade boards 120. Preferably, the media Codec 600, and its embedded CPU, are used to allow the blade boards 120 to perform system level tasks. In such an embodiment, the media Codec 600 uses its TS input 603 to receive demodulated transport streams from the TD unit 202. In addition, the media Codec 600 receives transport streams that comprise compressed, multiplexed and encrypted composed layout streams from each one of the blade boards 120. The media Codec 600 may store the layout streams on the HDD 116 or HD-DVD 118C. Preferably, the layout streams are forwarded to an internal screen, via the designated interface 148, or to an external screen via the display port 150. The media Codec 600 may be connected using the Ethernet interface 606, to the PHY/Link interface 139 in a manner that allows it to output the layout streams into the client stations through the communication link 104 or the TS interface 114.

In addition, the media Codec 600 may be used by the blade boards 120 to access a certain data source such as the Internet. The media Codec 600 receives the access demands via the TS interface 603 or the host bus interface 609. The media Codec 600 accesses requested data source via the PHY/Link interface 114 and forwards the requested data back to the requesting blade board 120 via the host interface 609, or via transport out interface 604.

The media Codec 600 may be used for providing the blade boards 120 with access to the embedded DVD 118C or the HDD 116. In such an embodiment, an access command is received from one of the blade boards 120 through the host interface, or through the TS output 133. In such an embodiment the media Codec 600 gathers the appropriate commands from host interface 609 or from the TS interface 603, access the HD-DVD 118C or the HDD 116, and send the multiplexed encrypted data into the blade board 120 through a TS output interface 604, or through host interface 609. The same is applied to the Media Codec 600's other shared resources, such as it's embedded Remote interface 124 unit, Screen 148, display 150 and the like.

As the media Codec 600, as described above, has all relevant encoding/decoding and capabilities, it can serve as a feedback unit a remote, and a redundant blade board. The functioning of these units is described above.

### Redundant Blade Boards

As described above, the home gateway 110 includes a blade board 120 which is separately associated with a different client station in the home media network 100. In some embodiments of the invention, the home gateway 110 includes one or more redundant blade boards 120, which are used when an error is identified in one or more of the used blade boards 120. In use, the CPU 122 detects, by directly communicating with blade board 120, or by using the feedback unit 144 for sampling the outputs of such a blade board, whether it is operative or not. The CPU provides operative blade boards 120 with an ID of the client station to which its signals are to be transmitted. Preferably, instructions correlating between blade boards 120, DTVs 102 and analog TVs 152 are directed to respective communication interfaces 134.

In one embodiment of the invention, a user notifies the CPU 122 when one of blade boards 120 is suspected of being inoperative, for example when the respective TV 102 fails to display video. Preferably, a feedback unit 144 monitors video signals which are transmitted on the RF communication link 104 and automatically determines whether one or more of the transmitted video layout streams is defective. Identification of a defective video layout stream may be used as an indication that the blade board 120 that is generating the layout stream has malfunctioned. Feedback unit 144 preferably includes a tuner, a demodulator, a decipher unit and a decoder. The feedback unit's demodulator may scan the video streams which are transferred on the communication link 104 to verify the robustness of all the received channels. The scanning may be done every predefined period. For example, the channels may be queried over duration of less than two minutes, or even over duration of less than 10 seconds.

Optionally, in automatically determining whether any of the blade boards 120 is inoperative, feedback unit 144 receives periodic snapshots of the generated layouts from blenders 208 and automatically compares the received snapshots with corresponding frames in the streams passing on communication link 104. If a corresponding frame is not found in the layout stream passing on communication link 104, the blade board 120 generating the layout is considered defective. In another embodiment, a predetermined number of frames are examined before making a final decision that a blade board 120 is defective. For example, if more than a predetermined number of consecutive frames received during step 400 in a single stream have the same values, the blade board that outputs the related layout stream is identified as being defective. Preferably, a layout stream is identified as being defective when a plurality of frames having the same pixels' values or a repetitive spatial pattern is identified.

In some embodiments of the invention, feedback unit 144 includes a small screen 148 on the housing of home gateway 110 that allows users to view the signals which have been transmitted on the communication link 104, preferably after they have been decrypted and decoded by feedback unit 144. The user may use small screen 148 in order to verify whether a faulty display on one of client station is an outcome of a fault in home gateway 110, a fault in the communication link 104, or a fault in the client station 102. Preferably, a user interface of home gateway 110 allows users to select one of the blade boards 120 and to display its outputs on the screen 148. In some embodiments of the invention, home gateway 110 includes a switching mechanism which allows selection of a video stream to be displayed on screen 148.

In another embodiment, the output of each blade board can be displayed using an external monitor which is connected through the display interface which could be located on the blade board 200, or device 120. Such a display interface could be implemented according to one or more protocols such as s-video, composite, component, HDMI/DVI etc.

Feedback unit 144 may be implemented as part of the CPU 122 or separately from the CPU 122. The feedback unit 144 may also be implemented as a separate external debugging device which is attached to home gateway 110 by a support technician. In such an embodiment, the home gateway comprises a connection that can readily connect technician equipment. In another embodiment each blade board 120 may have a built-in self test (BIST) function. Preferably, each blade board 120 includes a feedback unit 144 as an integral part of home gateway 110.

Different sensors may be used for identifying an error in one of the board blades 120. For example, temperature sensors, power sensors and any other sensors within the home gateway 110 may be used for identifying faulty blade boards 120 or blade boards 120 which require resetting or cooling-off period.

In some embodiments of the invention, upon identifying a malfunctioning blade board 120, the CPU 122 assigns a redundant blade board 120 to operate instead of the defective blade board 120. Optionally, if there is no available operative blade board 120, the defective blade board 120 is allowed to continue operation. Preferably, when a number of defective blade boards 120 are available, each defective blade board 120 is rated according to the severity of its defect, and the least defective blade board 120 is utilized. Preferably, an error notification is displayed on the display of the client station which is associated with the defective blade board 120. The error notification may comprise a severity value that reflects the severity of the malfunction.

Preferably, each client station 102 is given, either by a user or by a technician, with a priority value that is used to reflect the importance of its operation. When there are less operative blade boards 120 than active client stations, the operative blade boards are assigned to the client stations with the highest priority values.

The number of active blade boards 120 in a certain home gateway 110 may be determined according to statistical information which is automatically gathered regarding the usage of a certain client station. For example, if it is determined that only rarely are more than 80% of the client stations used in parallel, the home gateway 110 may include only the number of blade boards required for the 80% of the televisions. As a further alternative, one more blade board 120 than required for the 80% of Televisions may be provided, for redundancy.

While in some embodiments of the invention all blade boards 120 in home gateway 110 are identical, in other embodiments of the invention different blade boards 120 provide different levels of service. For example, one or more blade boards 120 may have a larger number of TD units 202 than the other blade boards 120. Optionally, one of the blade boards 120 has three TD units 202, while the remaining blade boards 120 only have two TD units 202. When a certain client station requests to view a layout with three video streams from input RF link 112, the requesting client station is assigned to the blade board 120 with the three TD units 202. In case more than one client stations requests to view three or more video streams the resources are divided according to a predefined arbitration method. Possible arbitration methods may comprise a step of ranking the preference of the client stations according to the timing of their requests or preferring a client station according to its priority value.

In an exemplary embodiment of the invention, a redundancy blade board 120 includes less TD units 202 than the other blade boards. The redundancy blade board 120 may also have limited abilities since it is generally used for short periods until a new replacement blade board 120 is supplied.

In one embodiment of the present invention, the home gateway 110 includes one or more blade boards that do not include blenders 208. Such blade boards include a simple switching unit instead of the blender 208. As no blender is used, the simple blade board includes only one TD unit 202. As order to reduce further costs, if the same encryption method is used by the demux/decipher unit 204 and the mux/cipher unit 212, the simple blade boards may include only tuner and demodulator units. Preferably, the simple blade boards further includes an encoder 210 for handling uncompressed video streams received from external audio/video content source 118A 118B 116. The home gateway 110 may also include simpler blade boards that include only an encoder 210 and mux/cipher unit 212 to service external CE devices. If such blade boards are used for ordinary usage and not as back up units, composite displays may be available at a given time for a limited number of users as there are less blenders than users. As described above, arbitration methods and priority values may be used to determine which of the client stations to associate with the blade boards that allow composite displays. The number of blade boards that do not include blenders is preferably determined according to statistical information regarding the watching habits of users.

In some embodiments of the invention, the simple blade boards may be used to prepare a video stream for storing external audio/video channels 118 for a later display.

Optionally, the assignment of blade boards 120 to display devices may be switched in real time, preferably in a manner that is transparent to the viewers, meaning the viewers do not notice the switch. Such a switch can be performed when a user requests to change from a simple display to a composite display. Alternatively or additionally, any time a user switches from a composite to a simple display, the blade board servicing the TV set is changed to a simple blade board, so as to keep the full scale blade board available for other televisions.

In one embodiment of the present invention, the home gateway 110 comprises a service interface which is used for establishing a connection with a server or another service station which is associated with a related service provider. Upon the identification of a defective blade board 120, the home gateway 110 uses a service interface to transmit a notification, such as a text message, to the service station of the service provider that provides support to the home gateway. The service interface preferably transmits the notification over a back channel of the RF input link 112. Preferably, the notification is transmitted via the data interface 114 as an e-mail message or via Short Message Service (SMS). Preferably, in one embodiment the notification is further presented to the user. For example, a message is displayed on a screen attached to the home gateway 110.

Based upon the notification, the service station may schedule a technician visit for the replacement of the defective blade board 120. The scheduling of the technician visit is optionally scheduled according to the severity of the fault, preferably in respect to the availability of redundant blade boards.

Preferably, the fault can be fixed remotely, by connecting the home gateway to a virtual private network (VPN) in a manner that allows remote installation of a software patch.

It should be noted that the technician visit may be scheduled at the initiative of the service station, without notifying the user of home gateway 110. Preferably, a home gateway 110 includes a user display on which a request to invite a technician is displayed either on the screen attached to a user of home gateway 110, when a defective blade board 120 is identified. The display optionally notifies the user of the identified problem and the measures used to prevent the problem from affecting the user.

In one embodiment of the invention, home gateway 110 allows connection and disconnection of a blade board 120 without interrupting the normal operation of other blade boards, so that TV viewers are not disturbed when a technician replaces a blade board. Optionally, CPU 122 is configured to allow the connection and disconnection of the other blade boards 120 which are designed with proper switches that allow the swapping of the defective blade board 120.

A home media network that comprises a large number of client stations may use a number of home gateways. In one embodiment of the present invention, a central controller is connected to different home gateways and directs their outputs to the client stations. Such a multiplicity of home gateways may be used to overcome fatal malfunctions in one of the home gateways, such as malfunctioning of the CPU. When such a fatal error occurs, the client stations that receive service from the inoperative home gateway may be directed to another home gateway, preferably according to their priority values. For example, when the HDD of one of the home gateways is inoperative, a client station that requests a playback service may be directed to another home gateway, while client stations that do not require playback services are serviced by the faulty gateway.

Preferably, some of the blade boards may generate more than one single layout stream. The client stations are assigned to the multi layout stream blade board according to the complexity of the requested layout streams of the televisions.

Further to employing blade board architecture, the home gateway 110 may also employ other architectures, such as a powerful central encoder and decoder units which substantially simultaneously handle a plurality of video streams.

### Information Sharing

As described above, the home gateway 110 allows a number of users to share resources and to access them from remotely located client stations that may be positioned in different places. In such an embodiment one user can share information with other users. For example, the home gateway allows one user to store a media stream on the HDD memory which can be accessed by other users. As the client stations are connected to the home gateway via the communication link 104, which is a bidirectional connection, the home gateway may be used for interactive communication between the users.

In one preferred embodiment of the present invention, the system is used to allow a video-conference between the users. In such an embodiment, a set of web-cameras is coupled to two or more client stations and connected, via a suitable connection such as a USB interface, to the communication link 104. The output video streams of the cameras are simultaneously transferred to the PHY/Links of the associated blade boards 120, as described above. As each one of the blade boards may transmit plain and composite video streams to another blade board, the video streams which are received from a certain camera which is associated with one blade board of a certain client station can be transmitted to another client station using the blade board it is associated with. Each one of the client stations which takes part in the video conference may receive a composite layout stream that comprises a scaled display of any of the outputs of any of the cameras that take part in the video conference. The composite layout stream is generated by one or more of the blenders 208, of blade boards which are associated with one of the participating client stations.

As described above, the home gateway is connected to the Internet. Preferably, as all the client stations are connected to the home gateway, such an embodiment allows all the users to share a single access to the Internet. Preferably, the home gateway implements QoS control, firewall module, VPN capabilities, and the like. It should be noted that the web-based applications, such as Skype™ or MSN messenger™ may be used to allow communication between the client stations as they are preferably connected to the Internet via the home gateway.

### Clients Setup

As described above, the home gateway is designed to simultaneously provide a number of users with different services via a respective number of client stations. Some of the aforementioned services are user dependent. For example, the home gateway allows a remote user to access particular media content via a certain client station. Such particular content is stored on the HDD 116 or on a certain CE appliance. In such an embodiment, the HDD 116 or a certain CE appliance may save media streams of the media content according to the user's request. Another example is related to the blade board's ability to generate PiPs. Such a PiP may be defined by a certain user from a certain client station.

Different users may want to use the services of the home gateway from client stations which are positioned in different locations, such as the living room, the bedroom or the study room. In one embodiment of the present invention, the home gateway 110 is designed to provide user dependent services to a certain user on any of the client stations. Preferably, the HDD 116 stores user related information about each one of users in designated records. The stored information includes the user's preferred setups, his most recently viewed channels etc. Preferably, the home gateway uploads login software, which is preferably stored on the HDD 166 that allows users to identify themselves at each one of the client stations. The above-discussed user information is saved onto HDD 188 when the user logs on, logs off, or when the user asks for the information to be saved. When a user is identified, all the user dependent features are adjusted according to his personal preferences. In such an embodiment, a user can have favorite channels, graphics, PiPs, etc. which can be made available to him at each one of the client stations. Moreover a user may watch or listen to certain media content in one room, log-out from the system and log-in in another room to start where he left off in the previous room.

Such an embodiment can also be used to restrict access to channels or stored content to one or more identified users, but make it freely available to that user wherever he logs on.

Thus, using the log-on feature above, a single TV can service multiple clients, so that for example when the first user logs off, a second can log-on and receive his pre-defined setup. This allows say the user to move from the living-room to the bed-room, and preserve the same “window-layout”. The user can either log out from the living room TV and log into the bedroom TV, or alternatively, log in from the bedroom while keeping the living room TV logged in as well.

Preferably, the home gateway device 110 actively scans the internal network 104 or the external network 114 for new client stations or for disconnected client stations. Preferably, when a new or a disconnected client station is detected the home gateway device 110 performs one or more adjustment operations such as measurement of available Bit-rate, assignment of blade board and appropriate configuration, DRM key exchange, user configuration etc. The adjustment operations allow the new client station to become a part of the home media network. The adjustment operations can be done either with or without the user intervention.

### Thin Client

Reference is now made to FIG. 4, which is a schematic illustration of a thin client 154, in accordance with one embodiment of the invention. The depicted thin client 154 includes a tuner 302 and a demodulator 304 that receives the signals transmitted on the communication link 104, which may be implemented over RF, but could be implemented over Ethernet cable, wireless networks etc. and output a layout transport stream to a decryption unit 306, which removes the encryption from the signals. A single program stream decoder 308 is configured to decode and transfer the decrypted program stream signal in an uncompressed format to an associated analog TV set 152. It is noted that, if desired, a single thin client 154 can be connected to a plurality of televisions 152, which all display the same layout. It is noted that thin client 154 is simpler than set top boxes and thin clients known in the art, as thin client 154 does not need to generate advanced 2D or 3D full resolution graphics planes or to arrange the layout stream by blending a number of video channels, displaying still images or rendering graphics planes to display.

A thin client for operation with DTVs is optionally similar to thin client 154, but outputs a video stream suitable for DTVs according to formats such as DVI and HDMI. Such thin clients may be used with non-standard televisions that do not support the format of the compressed layout streams which are generated by the home gateway. The thin client receives the composite layout stream and converts it into an uncompressed video stream in a digital format. Preferably, one or more of the thin clients comprise a simpler bridge which is designed to convert the received layout stream to a format supported by the TV set, such as a 1394/FireWire format, a DVI format, HDMI format, an Ethernet format, a USB format, or any other suitable format.

### External Video Storage Unit

Reference is now made, once again, to FIG. 3. As mentioned above, in one embodiment of the present invention, signals from external audio/video units 118, such as video storage units, are provided to blender 208. Preferably, the video signals are provided directly to encoder 210. The outputs of the blender 208 or the encoder 206 may be transmitted external video recording units, allowing the storage thereof on external storage units in accordance with an appropriate DRM scheme.

The signals received from external audio/video storage units 118 are optionally uncompressed. Therefore, in addition to receiving uncompressed video signals from external audio/video storage units 118, blade boards 120 may include one or more interfaces, such as USB or 1394 interfaces, which receive compressed or uncompressed video streams from an external storage unit. The received video streams are transferred to a decoder 206, which decodes the compressed video.

The video streams may be received in an encrypted format from external audio/video storage units 118. In such an embodiment the interfaces to external audio/video storage units 118 and to HDD 116 include a decryption unit and preferably a decryption unit which may be entirely separate or share some or all of the hardware, firmware and software with demux/decipher unit 204 and decoder 206 of the blade boards.

By storing compressed video in external video storage unit, blade boards 120 optionally include an output interface which leads compressed signals from the mux/cipher unit 212 to the external storage units. Such an embodiment allows storing of the encrypted or unencrypted video streams on external audio/video storage units 118. The home gateway 110 may be configured to allow storing the encrypted video streams, storing non-encrypted video or both. In order to avoid copyright infringement, the home gateway 110 may not allow external storage of some of the content or all the content of certain video channels, content of external CE devices, or any other content which is received from a content source which is connected to the home gateway 100.

Reference in now made, once again, to FIG. 2. The controllers of the external storage units are optionally connected to the CPU 122, as illustrated by line 177. Instructions for controlling external audio/video storage units 118 are preferably received from the CPU 122, according to control signals transmitted by the client stations or by remote controls 156 which are associated to the client stations. The CPU 122 transfers the received instructions to the relevant external audio/video storage unit 118 and in parallel instructs the blade board 120 which is associated with the instructing client station to display the output from the external audio/video storage unit 118, or CE device linked to 110 by any other connection. Preferably, control instructions are provided directly to the external audio/video storage unit 118, which provides instructions to CPU 122, when required. The control instructions may be transmitted using any communication method known in the art, including RF and infrared. The control instructions optionally control the operation of the home gateway 100 and the content which is provided by the external audio/video storage unit 118. For example, the control instructions include rewind, forward, fast forward, fast rewind, and video stream selection commands.

In one embodiment of the present invention, external video storage which is directly connected to the home gateway 110, such as a VCR 118A or a DVD 118B, allows the displaying of an outputted video stream on a number of client stations 102, 105, 154, and 174 using a number of blade boards 120. In addition, as a number of client stations 102, 105, 154, and 174 are connected to the home gateway 110, different client stations may share the same external audio/video storage unit 118, without requiring a direct connection between each one of the client stations and the external audio/video storage unit 118. Such architecture allows the audio/video storage unit 118 to provide service to a number of client stations without disconnecting and reconnecting wires.

For example, if the external audio/video storage unit 118 includes a random access hard disk, the storage unit may substantially simultaneously provide service to a plurality of client stations, which are located in different rooms, with different video streams.

In some embodiments of the invention, the housing home gateway 110 includes a predetermined number of interfaces to external audio/video storage units 118, each interface connecting to a single unit 118. Alternatively, home gateway 110 includes a bus interface which can be connected to a plurality of external storage units which share the bus interface.

As mentioned above, external audio/video storage units 118 may include VCRs, DVDs, IPODs, camcorders or any other video storage units, such as a hard disk, a portable video player, or a random access memory which is based on storage units. In some embodiments of the invention, the interface to the external audio/video storage unit 118 may be used for inputting from other devices, such as video cameras and/or computers. Alternatively or additionally to using external CE appliances, home gateway 110 may include internally one or more CE appliances, such as a DVD, HD-DVD, VCR and/or game console. Preferably, such an interface to the external audio/video storage unit 118 can be wired or wireless.

### Additional Features

CPU 122 of home gateway 110 may include additional features, such as personal video recording features (for example time shifting, pause and playback services). Other features may include a graphic user interface (GUI), an EPG, remote control, game support, advanced graphic editing, VOD and any other features suggested in the art for provision by set top boxes. It is noted that all these features are supported by the CPU 122 of home gateway 110, or by one or more of the blade boards 120, and there is no need for the features to be supported by televisions 102, 152 or by thin clients 154, 174. Thus, the costs of providing complex features that can be used, possibly concurrently, by a plurality of display units are incurred only once.

The features described herein are listed by way of example, and home gateway 110 may support additional or other features, for example features described in US patent publication 2003/0001978 to Smith et al. and US patent publication 2003/0210891 to Burda, which are incorporated herein by reference. It is also noted that the structure of home gateway 110 may be varied to use variations of elements or attributes as described in these patent publications.

### Network Arrangement

In some embodiments of the invention, the output layout streams are compressed and transmitted together on the communication link 104, for example using ATSC modulation. Alternatively or additionally, the output video streams are transmitted using the 802.11 protocol, the ultra-wide-band (UWB) protocol, USB, Firewire, HDMI/DVI, SMPTE292M, Ethernet, Wi-Fi, MoCA, HomePNA (HPNA) LAN, HomePlugAV and/or any other protocol suitable for transmission of video streams, particularly high definition video streams.

In some embodiments of the invention, the communication link 104 is a wired link such as a coaxial cable and a DVI is used. Alternatively, a wireless transmission link can be used. Further alternatively or additionally, any other type of communication link is used.

Compressing the video signals which are transmitted to the display unit, preferably allows the transmitting of video streams to a number of client stations on a single link, with a conventional bandwidth of less than 150 Mbps. A MoCA link having a capacity of about 140 Mbps or a wireless link having a capacity of about 25-30 Mbps may be used for allows the transmitting of video streams to a number of client stations.

Alternatively to using a single transmission link for communicating with all of client stations 102, 154, 174 and 168, a plurality of transmission links may be used. For example, each link may be used for servicing a sub-group of one or more of the client stations 102, 154, 174 and 168 in the home media network 100. Such an alternative is particularly useful in large networks, such as hotel communication networks. Some embodiments of the invention transmit the signals from blade boards 120 to the display devices, and the signals may be transmitted over dedicated cables to each of the display devices separately.

### Network

Network 100 may provide service to only a few display devices such as DTVs 102, analog televisions 152, or portable video players 168, PC 105, or any other remote client station. For example, less than five display devices may be used to provide service to a large number of clients, for example more than ten clients. It should be noted that in some cases it may be desired to have a number of home gateways 110 to provide service to a number of clients in order to increase the computational power and the memory capacity which is available to each one of the blade boards. Such an embodiment of the invention may be used when a network 100 includes tens or hundreds of client stations.

In an exemplary embodiment of the invention, a single home gateway 110 is used for multiple separate users, and different users may pay different sums for different levels of service. For example, a user may pay a small sum which allows use of a blade board only when there is an available blade board not used by other users paying higher subscription payments. A pay per use embodiment may require each user to pay according to the amount of time each type of blade board is used. CPU 122 optionally keeps track of the blade board usage and initiates billing orders, and preferably communicates such billing information through external interfaces, such as the Ethernet interface.

In some of the above described embodiments, home gateway 110 performs the entire task of generating the layout streams displayed on televisions 102, 152, from selecting and retrieving the base video streams to blending and generating the layouts. Optionally, all the components of home gateway 110 are housed within a single set top box. In some embodiments of the invention, home gateway 110 is entirely implemented on a single chip, except for HDD unit 116 and preferably TD units 202.

Performing the tasks of preparing the video layout streams centrally allows easier servicing of the system, for example performing software updates in a single central unit. In addition, as mentioned above, performing the tasks centrally by home gateway 110 allows the sharing of resources such as a redundant blade board among the hardware components that serves different client stations.

In addition to generating a video output layout stream, blender 208 also generates a mixed audio stream, for example, by selecting the audio of one of the input video streams. In some embodiments of the invention, blender 208 may transcode the format of the input audio stream used and/or may blend audio from several sources.

It is noted that although the invention herein reference is made to a video channel, it is intended to include the concept of a program or a transport channel. A program/transport channel may contain several video streams, for example, of the same channel viewed at different angles and the channel may have different associated audio streams for the user to select, thus for example, French, English, effects, and associated data (for example, program guide, subtitles etc.). Correspondingly, references to a video stream herein should be understood as including a Program Stream.

It should be noted that the connections among different units of home gateway 110 which are depicted in FIGS. 1 and 2 are exemplary, and different connections may be provided as alternatives or additions thereto. For example, external audio/video storage units 118 may be connected to transfer video streams through the CPU 122. In another example each one of the blade boards 120 comprises an internal hard disk.

It will be appreciated that the above described apparatus may be varied in many ways, including changing software implementations to hardware implementations or changing hardware implementations to software implementations. It should also be appreciated that the above described description of methods and apparatus are to be interpreted as including apparatus for carrying out the methods and methods of using the apparatus. It should be understood that features and/or steps described with respect to one embodiment may be used with other embodiments and that not all embodiments of the invention have all of the features and/or steps shown in a particular figure or described with respect to one of the embodiments.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims.

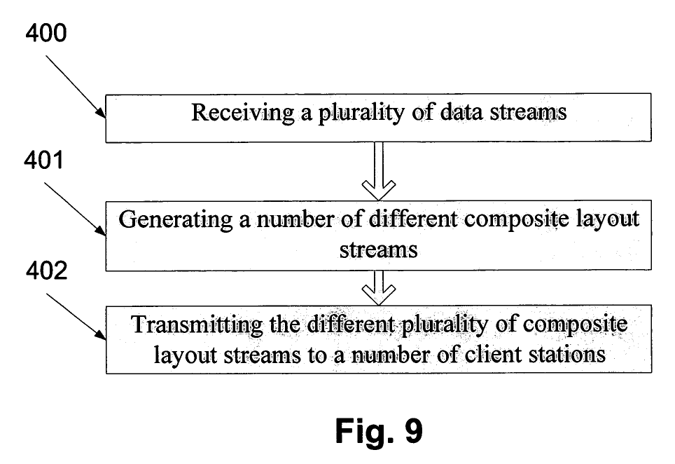

Reference is now made to FIG. 9, which is a flowchart of an exemplary method for providing composite layout streams to a number of client stations, according to a preferred embodiment of the present invention.

During the first step, as shown at 400, a number of data streams are a received from different content sources. The data streams are received at the home gateway. Than, during the following step, as shown at 401, the home gateway is used for generating a number of different composite layout streams. Each one of the different composite layout streams is generated according to one or more of the received data streams. Each composite layout stream may be encoded. The composite layout streams are generated using a blender which is used to combine two or more of the received data streams. Preferably an HDD is used for storing the composite layout streams. In the following step 402, as shown at 3, each one of the different composite, preferably encoded, layout streams is transmitted to a different of client stations. Such architecture allows a number of client stations to arrange a display according to different composite layout streams, allowing a number of users to simultaneously access different media channels or share contents together.

It is expected that during the life of this patent many relevant devices and systems will be developed and the scope of the terms herein, particularly of the terms client stations, CPU, blade boards, communication, and frames are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A home gateway for a home media network the home media network comprising content source inputs from any one of cable, satellite and digital broadcasting streams, digital data inputs including the Internet, and domestic content sources, and a plurality of terminal devices, each terminal device having a thin client, the home gateway comprising:
a plurality of input interfaces each configured for receiving data from a respective content source;
a multi-standard decoder unit capable of processing streams from the respective content sources, said processing being per stream according to a required one of a plurality of supported compression and encryption standards;
an internal stream generation unit able to create internally generated streams;
a layout generation unit adapted to generate substantially simultaneously a plurality of different composite layout streams, each one of said different composite layout streams being generated according to at least one of said plurality of input streams;
a multi-standard encoder unit capable of processing said composite layout streams, according to a variety of compression and encryption standards to produce reduced bandwidth output in a manner suitable for successful utilization by a thin client; and
a plurality of output interfaces for providing said composite layout streams to respective terminals.

2. The home gateway of claim 1, wherein said layout generation unit comprises a plurality of client layout circuitries, and each one of said plurality of client layout circuitries comprises at least one blender adapted to generate at least one of said plurality of said composite layout streams.

3. The home gateway of claim 2, wherein said blender is adapted to generate said composite layout stream from at least two members of the group consisting of: a first input stream from a respective content source, a second input stream from a respective content source and one of said internally generated streams.

4. The home gateway of claim 1, wherein said thin client is a thin client incorporated within a digital television.

5. The home gateway of claim 1, wherein said reduced bandwidth output is directed to an external client.

6. The home gateway of claim 1, further comprising a still image decoder capable of decoding still images, according to a required one selected from a variety of supported compression standards.

7. The home gateway of claim 1, wherein said processing at said multi-standard decoder unit comprises at least one of the group consisting of deciphering, demultiplexing, indexing, decompressing and decoding.

8. The home gateway of claim 1, wherein said processing at said multi-standard encoder unit comprises at least one of the group consisting of enciphering, multiplexing, indexing, compressing and encoding.

9. The home gateway of claim 2, further comprising a Central Processing Unit (CPU), said CPU being configured to substantially simultaneously support at least one of said plurality of client layout circuitries in the generation of said at least of said plurality of said composite layout streams.

10. The home gateway of claim 1, wherein said content sources comprises at least one member of the group consisting of: a cable link, a satellite link, a digital terrestrial TV link, an analog terrestrial TV link, a digital versatile disc (DVD) player, a video digital recorder (VDR), an external consumer electronic video appliance, a portable memory device, a portable video/audio player, the Internet, a local area connection (LAN), and a Video Home System (VHS).

11. The home gateway of claim 1, wherein said data comprises a member of the group consisting of: a base video channel, a compressed video stream, and an uncompressed video stream, a program channel, a composite of several video streams, a composite of several video and audio streams, a composite of several video streams depicting a common object from different angles, a video stream associated with a plurality of audio streams, a subtitle stream, an analog video stream, a digital video stream, an analog video channel, still images, auxiliary data and an electronic program guide (EPG) stream.

12. The home gateway of claim 1, wherein said client stations are configured to display said composite layout streams.

13. The home gateway of claim 2, wherein one of said client layout circuitries is connected to another of said client layout circuitries.

14. The home gateway of claim 13, wherein said one of said client layout circuitries is configured to generate said at least one composite layout stream according to at least one composite layout being generated by said other of said client layout circuitries.

15. The home gateway of claim 2, further comprising at least one encoder adapted to compress said plurality of different composite layouts.

16. The home gateway of claim 15, wherein each one of said blenders is associated with said at least one encoder, said at least one encoder being adapted to encode said at least one of said plurality of said composite layout streams.

17. The home gateway of claim 16, wherein said at least one blender and said at least one encoder are included on a single chip.

18. The home gateway of claim 1, wherein at least one of said plurality of output interfaces is adapted for transmitting at least one of said composite layout streams modulated on one member of the group consisting of: wire-line communication link and a wireless communication link.

19. The home gateway of claim 1, further comprising an internal storage unit adapted for storing at least one of said composite layout streams.

20. The home gateway of claim 19, wherein said layout generation unit is adapted for generating at least one of said plurality of different composite layout streams using said stored composite layout streams.

21. The home gateway of claim 19, wherein said internal storage unit comprises a random access memory (RAM) unit for storing said at least one of said composite layout streams.

22. The home gateway of claim 2, wherein each one of said plurality of client layout circuitries comprises at least one tuner and demodulator.

23. The home gateway of claim 2, wherein respective ones of said plurality of client layout circuitries are assigned to corresponding ones of said terminal devices.

24. The home gateway of claim 2, wherein at least one of said plurality of client layout circuitries comprises a built-in self test (BIST) module, wherein said BIST module is configured to generate an indication regarding a malfunction in a related client layout circuitry.

25. The home gateway of claim 24, wherein said indication is provided to an associated client station via a related output interface.

26. The home gateway of claim 1, further comprising a built-in self test (BIST) module and a service provider interface, wherein said home gateway is adapted to transmit a status indication via said service provider interface.

27. The home gateway of claim 1, further comprising a remote control unit, associated with said layout generation unit, for allowing at least one user to control the generation of said different composite layout streams.

28. The home gateway of claim 27, further comprising an internal storage unit, said remote control unit allows said at least one user to store at least one of said different composite layout streams on the memory of said internal storage unit.

29. The home gateway of claim 28, wherein said remote control unit allows said at least one user to provide video recording and control features.

30. The home gateway of claim 29, wherein the layout generation unit is adapted to apply said video recording and control features to at least one stream being output.

31. The home gateway of claim 1, wherein one of said content sources is a graphical engine module, and said layout generation unit is adapted to provide game support.

32. The home gateway of claim 1, wherein said plurality of devices comprises a member of the group consisting of: a digital television (DTV), a thin client device connected to an analog television, a thin client device connected to a DTV, a portable player, a personal computer, a mobile CE device, a games console, a communication device with a graphical interface, and a laptop.

33. The home gateway of claim 1, wherein at least one of said plurality of input interfaces is an external video interface adapted to interface with an external video storage device.

34. The home gateway of claim 33, wherein the external video interface is adapted to receive uncompressed video signals from said external video storage device.

35. The home gateway of claim 33, wherein the home gateway is adapted to provide remote control for said external video storage device.

36. The home gateway of claim 1, wherein at least one of said input interfaces is configured for receiving data from at least one camera.

37. The home gateway of claim 36, wherein ones of said plurality of different composite layout streams comprises inputs from said at least one camera.

38. The home gateway of claim 37, wherein said different composite layout streams allows a plurality of users to carry out at least one member of the group consisting of: sharing external CE devices, sharing programs recorded at the gateway, and participating in a conference call via said plurality of terminal devices.

39. The home gateway of claim 2, wherein at least some of said client layout circuitries comprise a media codec configured for receiving streams from one or more of said plurality of input interfaces.

40. The home gateway of claim 39, wherein said media codec is configured for processing said streams according to at least one members of the group consisting of: demultiplexing, decrypting, decoding, indexing, graphics generation, blending, play backing, encoding, multiplexing, encrypting, and transcoding.

41. The home gateway of claim 2, wherein said plurality of client layout circuitries are connected to said plurality of output interfaces via a central media codec.

42. A method of gatewaying streaming data for distribution to a plurality of terminal units, the method comprising:
a) receiving a plurality of incoming data streams in transmission formats,
b) receiving an internally generated stream,
c) processing said incoming data streams in transmission formats to manipulable formats,
d) performing manipulations on said manipulable formats to form new data streams for distribution to respective terminal units, said manipulations including at least one of the group comprising compositing and blending with said internally generated stream,
e) processing said new data streams to form outgoing data streams in transmission formats, and
f) outputting said outgoing data streams to said terminal units.

43. The method of claim 42, wherein said processing from a transmission format to a manipulable format comprises decompression, and said processing to form a transmission format comprises compression.

44. The method of claim 42, wherein said data streams are base video/audio and data channels.

45. The method of claim 42, wherein said processing of stage c) comprises demodulating.

46. The method of claim 42, wherein said processing of stage c) comprises descrambling.

47. The method of claim 42, wherein said processing of stage c) comprises decoding at least one of said streams.

48. The method of claim 47, wherein said stream is at least one of the group consisting of video, audio and still images.

49. The method of claim 42, further comprising a step of internally generating at least one of a 2D and a 3D graphics layout.

50. The method of claim 42, wherein said blending comprises blending of at least one of said plurality of video layouts with at least one of said plurality of still image layouts and at least one of said graphics layouts into at least one of plurality of composite layouts.

51. The method of claim 42, wherein said processing of stage e) comprises at least one of the group consisting of encoding, multiplexing and encrypting of at least one of said plurality of composite layouts.

52. The method of claim 42, further comprises a step of displaying at least one of said plurality of different composite layout streams on a digital TV set.

53. The method of claim 42, wherein said plurality of client stations comprises a member of the group consisting of: a digital television (DTV), a thin client device connected to an analog television, a thin client device connected to a DTV, a portable player, a personal computer, a mobile CE device, and a laptop.

54. A device for allowing the generation of a display according to a composite layout stream, comprising:
an input interface configured for receiving said compressed composite layout stream from a central home gateway via a local network;
a modulation unit, associated with said input interface, configured for modulating said compressed composite layout stream; and
an output interface unit for transmitting said modulated composite layout stream to at least one associated client station.

55. A method of configuring a home gateway for users connected via client stations, the method comprising:
gathering statistical information regarding the usage of said users;
using said statistical information for estimating usage patterns for said respective users; and
configuring said home gateway to allocate resources to respective client stations in accordance with said estimating.

56. The method of claim 55, wherein said designated home gateway comprises a plurality of client layout circuitries, each one of said client layout circuitries being configurable for assignment to a respective client station.

57. The method of claim 56, wherein respective ones of said client layout circuitries have different levels of on-board resources, said configuring comprising providing circuitries with higher resource levels to users indicating higher usage.

58. The method of claim 57, wherein said different levels of on-board resources comprise different numbers of on board blenders.

59. A method for transmitting streaming media to an external client using minimal bandwidth, the method comprising:
a) receiving a plurality of incoming media streams in a transmission format;
b) obtaining an internally produced media stream in a manipulable format;
c) processing said incoming media streams from said transmission format into a manipulable format;
d) from at least two of said plurality of incoming media streams and said internal media stream performing manipulations to generate at least one composite layout stream in said manipulable format;
e) processing said at least one composite layout stream from said manipulable format into a transmission format; and
f) transmitting said at least one composite layout stream to said least one remote client station for processing into a playable format.

60. The method of claim 59, wherein one of said plurality of data streams comprises IP based content.

61. The method of claim 61, said Internet based content is represented in hypertext markup language (HTML).

62. The method of claim 61, wherein at least one of said plurality of data streams comprises a member of the group consisting of: a base video/audio channel, a compressed video/audio stream, and an uncompressed video/audio stream, a program channel, a composite of several video/audio streams, a composite of several video/audio and audio streams, a composite of several video/audio streams depicting a common object from different angles, a video/audio stream associated with a plurality of audio streams, a subtitle stream, an analog video/audio stream, a digital video/audio stream, and an electronic program guide (EPG) stream.

63. An electric circuit for allowing at least one remote client station to display a composite display, said electric circuit comprising:
an input interface configured for receiving at least one video stream and at least one stream of IP based content;
a layout generation unit adapted to generate substantially simultaneously a plurality of different composite layout streams, each one of said different composite layout streams being generated according to said at least one video stream and said at least one stream of IP based content; and
a plurality of output interfaces for providing a plurality of client stations with the ability to access at least one of said plurality of different composite layout streams.
